(19) United States
(12) Patent Application Publication
(10) Pub. No.: US 2006/0085545 A1
(43) Pub. Date: Apr. 20, 2006

(54) Session initiation protocol-based routing support apparatus and method

(75) Inventors: Michael Borella, Naperville, IL (US); Guanglu Wang, Buffalo Grove, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Incorporated

(21) Appl. No.: 10/840,083

(22) Filed: May 6, 2004

(51) Int. Cl. G06F 15/16

(52) U.S. Cl. 709/227

(57) ABSTRACT

A Session Initiation Protocol (SIP) proxy is dedicated, at least in part, to supporting routing of communications for a plurality of clients (such as push-to-talk mobile clients) in a given region. In a preferred embodiment, such support exists notwithstanding that at least some of the clients are able to present any of a plurality of differing user identifiers. In particular, differing user identifiers are nevertheless recognized and used by the SIP proxy(ies) to effect compatible provision of a service such as push-to-talk services.

### FIELD OF THE INVENTION

This invention relates generally to network communications and more particularly to session initiation protocol-based communications and uniform resource identifiers.

### BACKGROUND OF THE INVENTION

Session Initiation Protocol (SIP)-based communications are well known in the art and include the use of so-called SIP proxies. In general, SIP routing serves well in many instances to support certain kinds of communications. There exist communication and technology paradigms, however, that are not presently well served by SIP. So-called push-to-talk communications comprise one such example.

Push-to-talk communications are typically characterized by a walkie-talkie style exchange of half-duplex voice transmissions. Usually one group member will transmit at some given time while other group members may only listen. Recent efforts have sought to implement such push-to-talk service in a packet-switched network using, for example, voice-over-Internet applications.

Unfortunately, various impediments exist that frustrate, at least to some extent, a fully satisfactory Internet protocol-based push-to-talk application. Some of these impediments are variations of typical concerns faced by network designers (providing, for example, support for multiple regions and/or roaming, compression, and presence information, to name a few). In other cases, however, such impediments can be more unique (and troubling).

For example, for various reasons, it can be desirable (or even necessary) that a given client (such as a wireless mobile client) have more than one user identifier. In many cases at least two such identifiers are desired. These can include, but are not limited to, an SIP uniform resource identifier and a telecommunication-system uniform resource identifier (such as a telephone number). While so provisioning a given client platform does not present a significant challenge in many instances, network compatibility and/or robust network operation on the other hand can be greatly stressed. Network complexity, cost, and/or latency delays can become technologically or commercially unacceptable when trying to assure effective compatible interaction with such multiple-identifier client platforms.

As another example, a given system may support clients that each use only a single identifier, but different clients may use different forms of identifier. Ensuring compatible support for such differing clients can be problematic.

### BRIEF DESCRIPTION OF THE DRAWINGS

The above needs are at least partially met through provision of the Session Initiation Protocol-based routing support apparatus and method described in the following detailed description, particularly when studied in conjunction with the drawings, wherein:

FIG. 1 comprises a block diagram as configured in accordance with various embodiments of the invention;

FIG. 2 comprises a block diagram as configured in accordance with various embodiments of the invention;

FIG. 3 comprises a schematic system view as configured in accordance with various embodiments of the invention;

FIG. 4 comprises a schematic system view as configured in accordance with various embodiments of the invention;

FIG. 5 comprises a flow diagram as configured in accordance with various embodiments of the invention;

FIG. 6 comprises a block diagram as configured in accordance with various embodiments of the invention;

FIG. 7 comprises a signal flow diagram as configured in accordance with various embodiments of the invention;

FIG. 8 comprises a flow diagram as configured in accordance with various embodiments of the invention;

FIG. 9 comprises a flow diagram as configured in accordance with various embodiments of the invention;

FIG. 10 comprises a flow diagram as configured in accordance with various embodiments of the invention; and

FIG. 11 comprises a flow diagram as configured in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION OF THE INVENTION

Generally speaking, these various embodiments support session initiation protocol (SIP) proxy-based routing as regards communications for at least a given region. In general, an SIP proxy is dedicated, at least in part, to supporting routing of communications for a plurality of clients in the given region. Pursuant to a preferred approach, at least some of these clients each have a plurality of differing user identifiers. More particularly, for at least one of these clients, at least two of the plurality of differing user identifiers each corresponds to a same first communication service. In a preferred embodiment this SIP proxy has access to memory to aid in facilitating such support.

In one embodiment, the plurality of differing user identifiers that each corresponds to a same first communication service comprise user identifiers as corresponds to a push-to-talk communication service. Pursuant to one approach, one such user identifier can comprise a standard SIP uniform resource identifier format and another such identifier can comprise a standard telecommunications uniform resource identifier format. In such embodiments, and pursuant to a preferred approach, at least one such SIP proxy will operably couple to a push-to-talk server.

Depending upon the needs of the application, additional regions can be supported in a similar fashion (which regions may, or may not, overlap with one another and may, or may not, represent a same or a different service, provider, or contracted area of coverage). When so configured, in a preferred approach, roaming may be supported as well.

So configured, one or more SIP proxies can be dedicated, at least in part, to supporting routing of communications for a plurality of clients in a given region, wherein at least one of the plurality of clients has at least two differing uniform resource identifiers by which to identify itself. Upon receiving a communication from a client that uses a first one of the at least two differing uniform resource identifiers, one can then automatically facilitate a first kind of communication for that client. Upon receiving a communication from a client that uses a second one of the at least two differing uniform resource identifiers, one can then automatically again facilitate that same first kind of communication for that client. This permits, for example, a client to have access to push-to-talk services regardless of whether that client proffers an SIP formatted identifier or a telecommunications formatted identifier to the SIP proxy.

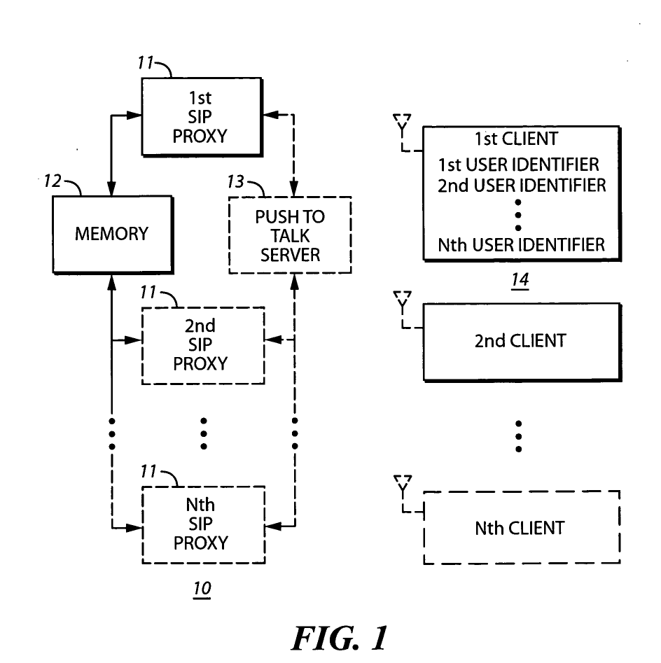

Referring now to the drawings, and in particular to FIG. 1, an illustrative system 10 comprises one or more SIP proxies 11. This specifies the use of at least one SIP proxy, but can include essentially any number of additional SIP proxies. The particular number of SIP proxies as provided for a given embodiment can of course vary with the specific needs of that embodiment (taking into account such well understood criteria as system loading expectations, geographic footprint, quality of service requirements, and so forth).

In a preferred embodiment at least one of these SIP proxies 11 is operably coupled to at least one memory 12. This memory 12 can comprise a standalone platform (as suggested by the illustration) or can comprise a partially or wholly integrated element of one or more of the SIP proxies 11 themselves. Those skilled in the art will also appreciate that such memory can comprise a local resource or can be remotely located with respect to the SIP proxies 11. Such memory 12 can serve a variety of useful purposes. For example, such memory 12 can serve to store user identifier information to thereby facilitate the actions described herein.

Pursuant to a preferred approach, an SIP proxy 11 comprises an SIP proxy engine and a push-to-talk server interface to facilitate operable coupling of the SIP proxy engine to an optional push-to-talk server 13. Pursuant to a preferred embodiment, the SIP proxy engine has at least a first mode of operation wherein the SIP proxy engine will facilitate a push-to-talk communication for a push-to-talk client that communicates an SIP message to the SIP proxy containing either of at least two different client identifiers as are available to that push-to-talk client.

Depending upon the needs of a given application, this first mode of operation can further optionally comprise facilitating decompression of compressed SIP messages/traffic as received from the push-to-talk client (where such compression serves, for example, to conserve system bandwidth and particularly bandwidth of wireless link portions of the system). Similarly, this mode of operation can optionally accommodate compression of SIP messages/traffic as are to be transmitted to the push-to-talk client (again, to thereby improve, for example, airlink utilization as between a given one of the push-to-talk clients and a given one of the SIP proxies).

As another example, this first mode of operation can also comprise facilitation of authentication and/or registration of the push-to-talk client. For example, the SIP proxy can serve, if desired, as a registrar for mobile clients. When providing such authentication/registration services, a preferred approach comprises supporting a given client with such services regardless of whether that client presents either of at least two different available-to-the-client client uniform resource identifiers to accord with the teachings set forth above.

As yet another example, this mode of operation can also optionally accommodate the making of routing decisions of SIP messages as are sourced by or directed to the push-to-talk client with respect to other portions of the system (or elements external to the system). Such routing decisions can be facilitated through use, for example, of a directory server and can be employed, if desired, to effect routing decisions for all SIP messages as are provided thereto.

Yet another option is to permit the SIP proxy engine, via this first mode of operation, to facilitate supporting distribution of presence information regarding the push-to-talk client. When the SIP proxy supports presence service(s), such service can be provided for one or more of the push-to-talk clients as are located within a given region as corresponds to a service area for the SIP proxy. Such service can be facilitated in various ways including, but not limited to, by the use of SIP/SIMPLE messages.

Such options can be supported given a wide variety of architectural conditions but may be particularly useful to employ when the relevant SIP proxy comprises a first hop SIP proxy with respect to the push-to-talk client (that is, when there are no other SIP proxies physically or logically interposed between the relevant SIP proxy and the push-to-talk client). Aside from such elements and/or functionality as is set forth above, SIP proxies are well understood in the art. Therefore, additional embellishment and details regarding such SIP proxies are not provided here for the sake of brevity and the preservation of relevant focus except where particularly relevant to the following discussion.

Such a system 10 serves to facilitate the communication needs of a plurality of clients 14 for a given region. Pursuant to these illustrative embodiments, at least some of these clients 14 each have a plurality of differing user identifiers where at least two of the plurality of differing user identifiers each corresponds to a same first communication service (such as, for example, a push-to-talk communication service) (or, in addition or in the alternative, some of the clients may use only a single user identifier but different clients within the system may use user identifiers having differing forms from one another—for ease of description, however, only the multi-identifier style of client will be referred to below in these illustrative descriptions). There is no particular upper limit to the number of differing user identifiers that can be so supported. In a preferred embodiment, at least one of the user identifiers comprises an identifier having a standard SIP uniform resource identifier format while another of the plurality of differing user identifiers comprises an identifier having a standard telecommunications uniform resource identifier format.

As noted above, as an optional embodiment, the system 10 can further comprise a push-to-talk server 13 (to thereby effect support for push-to-talk communications services for the plurality of clients 14). When so provided, the at least one (and preferably all when multiple SIP proxies are provided) of the SIP proxies 11 operably couples to the push-to-talk server 13 to facilitate the provision of such services. The push-to-talk server 13 can be comprised in accord with present or hereafter-developed practice. In a typical embodiment the push-to-talk server 13 can communicate with signaling elements using SIP or SIP/SIMPLE and with media components (via, for example, bearer paths) using RTP in accord with present well-understood practice.

Also as noted above, the system 10 can serve to facilitate the communication needs of a given region. Pursuant to one embodiment, such a region can comprise a plurality of push-to-talk service domains that each have a corresponding uniform resource identifier domain name. Pursuant to another embodiment, such a region can comprise a push-to-talk service domain of a push-to-talk service having a plurality of push-to-talk service domains that each have a corresponding uniform resource identifier domain name. Pursuant to yet another illustrative embodiment, such a region can serve the communication needs of push-to-talk clients having user identifiers that comprise at least one of a domain name and a sub-domain name that is distinct from any domain name and sub-domain name, respectively, as is assigned to any network component in the system 10.

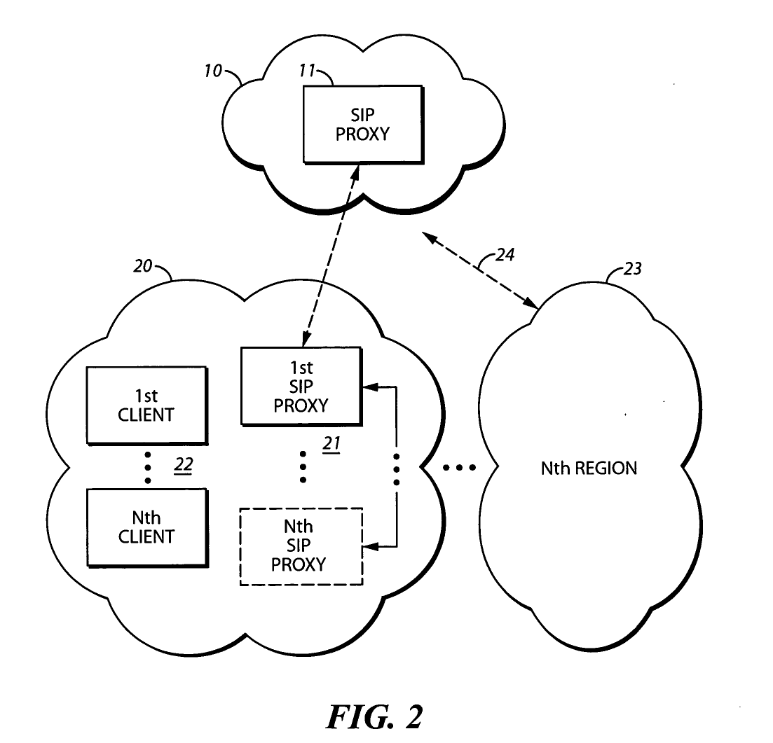

Referring now to FIG. 2, such a system 10 also operably couple to at least one other region 20. Pursuant to one embodiment, such a region 20 would itself comprise its own SIP proxy 21 (or proxies) that is similarly dedicated, at least in part, to supporting communications for a corresponding plurality of clients 22 in that region 20. In a preferred approach, and as described above, at least some of these clients 22 would each have a plurality of differing user identifiers where at least two of the user identifiers would each correspond to a same communication service notwithstanding their respective differences. Such a region-to-region coupling will preferably be effected by a coupling as between an SIP proxy 11 in the first region 10 with an SIP proxy 21 in the second region 20. So configured, these SIP proxies can support inter-region push-to-talk styled communications as between push-to-talk clients that are located in the different regions.

In a similar fashion, other regions 23 could be similarly configured and coupled 24 to the first region 10 to thereby further extend the services supported by the first region 10 including, for example, push-to-talk services as are supported via the SIP proxy or proxies of the first region 10.

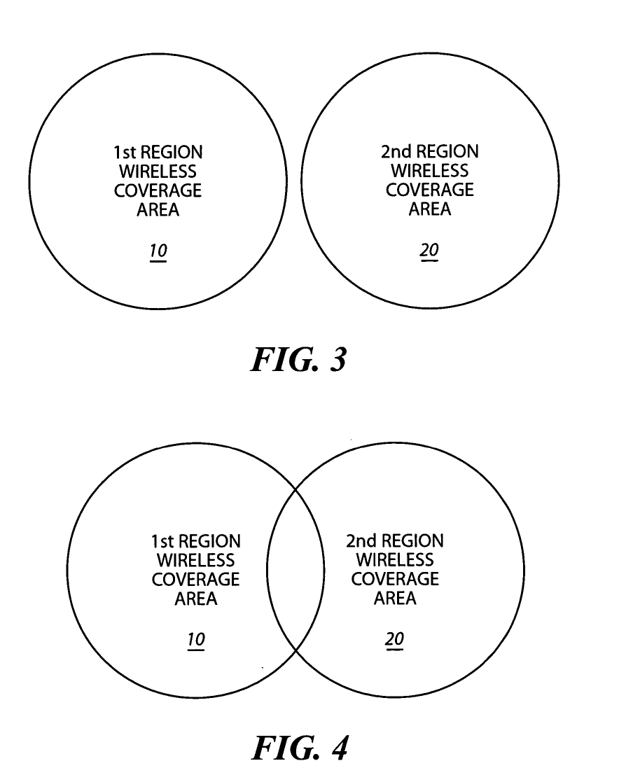

Such regions may, or may not, have overlapping coverage areas. This statement includes wireless portions of such regions. For example, with reference to FIG. 3, the wireless coverage area as corresponds to the first region 10 may, in a given deployment, avoid overlapping any portion of the wireless coverage area as corresponds to a second region 20. Or, in the alternative, and referring now to FIG. 4, such coverage areas may at least partially overlap (up to and including a scenario where one of the coverage areas is completely subsumed within the coverage area comprising the other region). These teachings are readily applicable and of benefit regardless of whether such overlapping conditions exist or not.

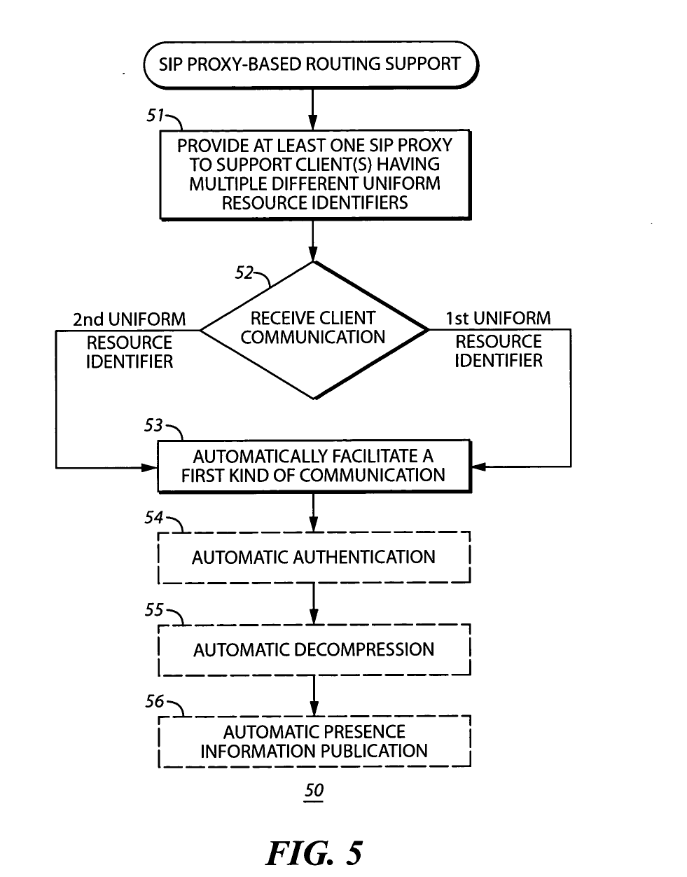

Referring now to FIG. 5, such a system platform (or any other enabling platform of choice) can serve to effect a process 50 that provides SIP proxy-based routing support. This process 50 provides 51 for at least one SIP proxy that is dedicated, at least in part, to supporting the routing of communications for a plurality of clients in a given region, wherein at least one of the plurality of clients has at least two differing uniform resource identifiers by which to identify itself. In a preferred but not required approach, the SIP proxy (or proxies) has a system name having a session initiation protocol uniform resource identifier that is different than any session initiation protocol uniform resource identifier as is assigned to any of the plurality of clients. When the region comprises a plurality of push-to-talk domains and there are a plurality of SIP proxies, at least some of the plurality of SIP proxies are preferably assigned to different ones of the push-to-talk domains to thereby facilitate push-to-talk services for various ones of the clients throughout such domains.

Upon receiving a communication from one of the plurality of clients (such as a communication seeking to establish a push-to-talk communication), this process 50 facilitates a determination 52 regarding whether the communication uses a first uniform resource identifier (such as an SIP uniform resource identifier) or a second, different uniform resource identifier (such as a telecommunications uniform resource identifier). As related above, this process 50 compatibly accepts at least both of these two different identifiers to then automatically effect facilitation 53 of a corresponding first kind of communication. For example, this process 50 can automatically facilitate 53 a wireless (or wireline) push-to-talk communication for that respective client.

So configured, a given client platform that uses two or more different identifiers can nevertheless gain access to a given communication service, such as push-to-talk service, without necessarily requiring strict protocols regarding which of those many identifiers to use when initiating such service. This can benefit both local clients and roaming clients as well by increasing flexibility while tending to ensure reliable communications. This can also benefit system operators in a similar fashion.

Such a process 50 can support other actions as well, of course. For example, this process 50 can optionally automatically authenticate 54 the client and/or its communication request. Such authentication can occur via one (or more) of the SIP proxies (such as, for example, an SIP proxy serving as, or having access to, an authentication server). As another example, this process 50 can optionally automatically effect decompression 55 of, for example, an SIP communication from the client(s) and/or can automatically effect compression of an SIP communication intended for receipt by a client. As yet another example, this process 50 can optionally automatically publish 56 presence information as regards the client. For example, upon receiving an SIP communication from a given one of the clients, the corresponding SIP proxy can automatically publish corresponding presence information regarding that client. (Note: for purposes of illustration, such illustrative “other actions” are shown in FIG. 5 as occurring subsequent to facilitation of the first kind of communication. Those skilled in the art will recognize that such other actions can be implemented at other times as well in a manner totally consistent with these teachings.)

Those skilled in the art will appreciate that the above general precepts can be employed in a variety of ways to meet the needs of a given context and application. The following more-detailed description of a particular embodiment will therefore be understood to serve an illustrative role rather than as an exhaustive example of all the ways in which these teachings can be successfully employed.

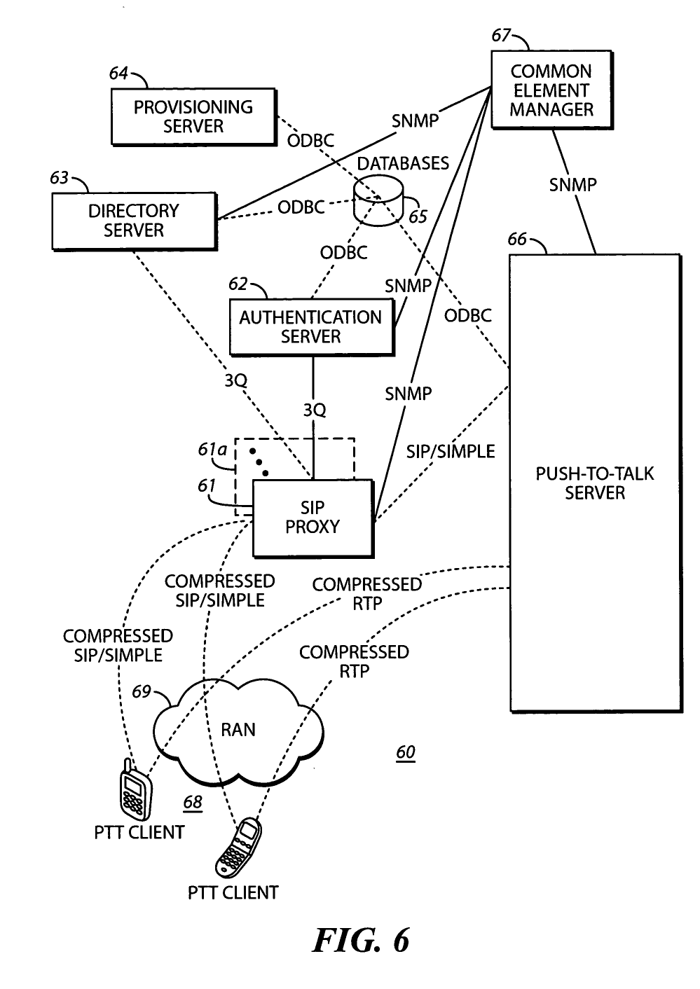

FIG. 6 depicts a logical view of an architectural configuration for a system 60 that provides push-to-talk services in accord with these teachings. This illustrative system 60 comprises an SIP proxy 61 configured and arranged as described above. This SIP proxy 61 operably couples in this embodiment to an optional authentication server 62 and an optional directory server 63. The authentication server 62 and directory server 63 are commercially available network elements and require no further description here. The operable coupling between these network elements and the SIP proxy 61 can be realized in a variety of ways. This coupling can comprise for example, RADIUS and/or DIAMETER as are well understood in the art. This illustrative embodiment also includes a provisioning server 64 and one or more databases 65. Provisioning servers and network-based databases are also well known in the art and require no further elaboration here. In this embodiment, the authentication server 62, the directory server 63, and the provisioning server 64 all operably couple to the database(s) 65 using Open Data Base Connectivity (ODBC), a well recognized standard database access protocol.

A common element manager 67 operably couples (using, for example, the Simple Network Management Protocol (SNMP) standard network device management protocol) to various of the above noted elements including, in this illustrative embodiment, the SIP proxy 61, the push-to-talk session manager 66a, the authentication server 62, and the directory server 63. So configured, the common element manager can effect management of essentially all system components with the exception of the database(s) 65 and the provision server 64.

It will be readily understood by those skilled in the art that these network elements can be physically configured in a discrete fashion from one another (as suggested by the illustration) or can be combined, in whole or in part, on a shared platform. As but one example of many, elements such as the authentication server 62 and the directory server 63 can have their database requirements met through use of a collocated physically discrete database. It will also be understood that various of these elements can be physically located proximal, or remote, to one another as may best suit the requirements and/or constraints of a given deployment.

So configured, various wireless push-to-talk clients 68 can communicate via a radio access network 69 (as are well understood in the art) with the SIP proxy 61 (via, for example, an SIP/SIMPLE protocol that may also support compression as desired) and the push-to-talk media processor 66d (via, for example, the Real-time Transport Protocol (RTP) which again may be compressed as desired.

The described illustrative embodiment depicts only a single domain/region. Multiple domains (each essentially resembling the embodiment described) can of course be provided. Also, there may be more than one instance of each element to permit or otherwise facilitate scalability, performance requirements, quality of service, and so forth. As one specific example in this regard, such a system 60 can, and likely often will, comprise additional SIP proxies 61a.

Such a system 60 can be readily employed to facilitate SIP-based routing of push-to-talk services-related communications. In particular, such a system 60 can support the use of regions that are defined by domain names (hence allowing a large operator a more flexible deployment strategy by compartmentalizing their network into operational areas to thereby permit support of literally millions of clients). Such a system 60 can further provide:
Support for multiple user identifiers per client to thereby allow, for example, a mobile client to be addressed by either an SIP uniform resource identifier or a telecommunication uniform resource identifier as corresponds to that client;
Support for multiple SIP proxies per region to thereby permit essentially indefinite scalability with respect to the number of clients that may be supported in a given region;
Support for SIP compression to thereby optimize airlink utilization between a mobile client and a first-hop SIP proxy;
Support for presence information;
Support for roaming; and;
Support for inter-region calls such that clients in one region can readily locate and contact a user in another region.

In a preferred embodiment the push-to-talk functionality of the above-described system 60 can reply upon certain assumptions regarding the use of SIP uniform resource indicators and domain names. These assumptions serve, in general, to facilitate scalabilty, ease of deployment, and/or efficiency with respect to routing within the SIP infrastructure. These preferred assumptions govern how domain names are defined for users, network elements, and so forth.

In general, pursuant to these assumptions, the push-to-talk system is divided into domains. Each domain can be considered a regional or administratively distinct push-to-talk system, although a single region or administrative entity may include multiple push-to-talk domains. The push-to-talk system defined by a domain is a standalone system capable of all relevant push-to-talk functions (including but not limited to registration, presence, calls, and so forth) within its own domain. In general, each push-to-talk client will have only one pre-assigned home domain. A service provide, however, may have multiple domains, such as “a.operator.com,” “b.operator.com,” “c.operator.com,” and so forth. (Note: “Roaming” refers in general to a client of a particular domain being able to access push-to-talk service from outside their home domain. “Roaming” does not necessarily imply that more than one service provider is involved, however. “Inter-domain” refers to calls or traffic that traverses one or more domains. For example, if user1 in domain A calls user2 in domain B, the call is an inter-domain call.)

Network elements shall be understood to encompass all of the servers in the push-to-talk system that communicate using Session Initiation Protocol (SIP). Such network elements include but are not limited to SIP proxies, push-to-talk servers, and presence servers as noted above. Network elements may all be in the same domain or can be spread across multiple domains. In this preferred approach, each network element is assigned to one or more local domains and will be aware of the names of those local domains (such as “a1.operator.com,” “a2.operator.com,” and so forth). The individual host name portion of the domain name can be selected in a relatively arbitrary manner provided it does not overlap with the specific sub-domain(s) as are assigned to push-to-talk clients.

The SIP uniform resource identifiers of all push-to-talk clients in a given domain will preferably have one or more distinct domains or sub-domains. It is strongly urged that the domains and/or sub-domains as assigned to clients be distinct from those that are assigned to network components. Observance of this recommendation permits an SIP proxy to be able to determine from the domain part of the SIP uniform resource identifier whether or not the uniform resource indicator refers to a client or to a network element and thereby likely makes routing more efficient and scalable. For example, presuming a domain name of a.operator.com, valid user domains can be “users.a.operator.com,” “subs.a.operator.com,” “ptt.myisp.com,” and the like. The first two examples provided above are examples of sub-domains of “a.operator.com” and represent a typical approach to defining a user sub-domain. The third example provided above will typically need to be more strictly associated with the domain “a.operator.com” and may not be suitable for use outside of that domain. (Note that even “a.operator.com” could be used presuming its uniqueness for this domain and its difference from those names as are used for network elements.)

As noted above, these teachings permit a push-to-talk mobile client to be uniquely identified with at least two uniform resource identifiers. One such identifier can comprise standard SIP uniform resource identifier formatting such as “sip:user1@users.a.operator.com.” Note that, in a preferred embodiment, the naming conventions set forth above will continue to be observed when selecting a specific SIP uniform resource identifier. Another such identifier can comprise telecommunications uniform resource identifier formatting such as tel:3121235555. This type of uniform resource identifier can be necessary when a client needs to interact with another client based on their Mobile Directory Number (MDN) rather than a username and domain. Pursuant to a preferred approach, a push-to-talk client enabled with two such uniform resource identifiers is able to use them interchangeably. For example, when a push-to-talk client registers with its SIP uniform resource identifier, other push-to-talk clients and network elements shall nevertheless be able to communicate with that client via its telecommunication uniform resource identifier. It is to effect such a capability, of course, that the above-described SIP proxies are able to support such dual-uniform resource identifier features.

As noted above, there may be more than one push-to-talk region (where a push-to-talk region is defined to be a complete standalone push-to-talk deployment). Different regions that have Internet Protocol connectivity will preferably allow roaming and inter-domain scenarios. There are numerous ways to handle roaming.

One preferred approach requires full Internet Protocol connectivity between all domains. To illustrate, assume that a first user's home domain is “a.operator.com” and that this first user is roaming in region “b.operator.com.” This client will sign on to the network for the latter region and query for the SIP domain name server records that belong to a.operator.com. Upon receiving the Internet Protocol address of the SIP proxies of a.operator.com, the push-to-talk client will register with one of those proxies. Further communication transactions would then proceed essentially as though the client was not roaming.

Another approach requires the roaming client to register via the local SIP proxy (that is, the SIP proxy for b.operator.com). The registration will still be with the SIP proxy of the home domain (that is, a.operator.com) but the SIP proxy of the local domain will be the first hop SIP proxy and will therefore perform SIP compression/decompression with the push-to-talk client. When calls are set up, the local SIP proxy has a choice of sending the calls to a push-to-talk server in the home or the local domain. This decision can be resolved in various ways. For example, the choice can be based upon the called parties (for example, if all of the called parties are in the local domain, using a local push-to-talk server may be preferred, while a home domain push-to-talk server may be preferred when the called parties are a home domain defined group).

In a preferred approach the SIP proxy will use SIP Hyper Text Transfer Protocol (HTTP) digest authentication during the registration process for a given push-to-talk-client to authenticate that client. Preferably, only authenticated push-to-talk clients are permitted to register. Upon successfully authenticating such a client, the SIP proxy can use a 3Q AUTH_UPDATE message to inform the authentication server that the SIP proxy is the push-to-talk client's serving SIP proxy. Such a message will preferably contain both (or all) uniform resource identifiers for a client when such multiple identifiers exist for a given client. This, in turn, will permit the SIP proxy to readily correlate the registered uniform resource identifier with the other uniform resource identifier(s) in, for example, a registration list.

As noted above, each domain may have an essentially arbitrary number of SIP proxies. Since push-to-talk clients may come and go relatively frequently, such clients may register with a different SIP proxy with each new registration. This, in turn, suggests that the user uniform resource identifier alone may not be usable to locate a given push-to-talk client. Messages coming from the network elements in the local domain (or from remote domains) may be sent to a local SIP proxy that is not presently the serving SIP proxy for a given target SIP push-to-talk client. Therefore, preferably, all SIP proxies in a domain are configured and supported so as to be able to locate the local serving SIP proxy under such circumstances.

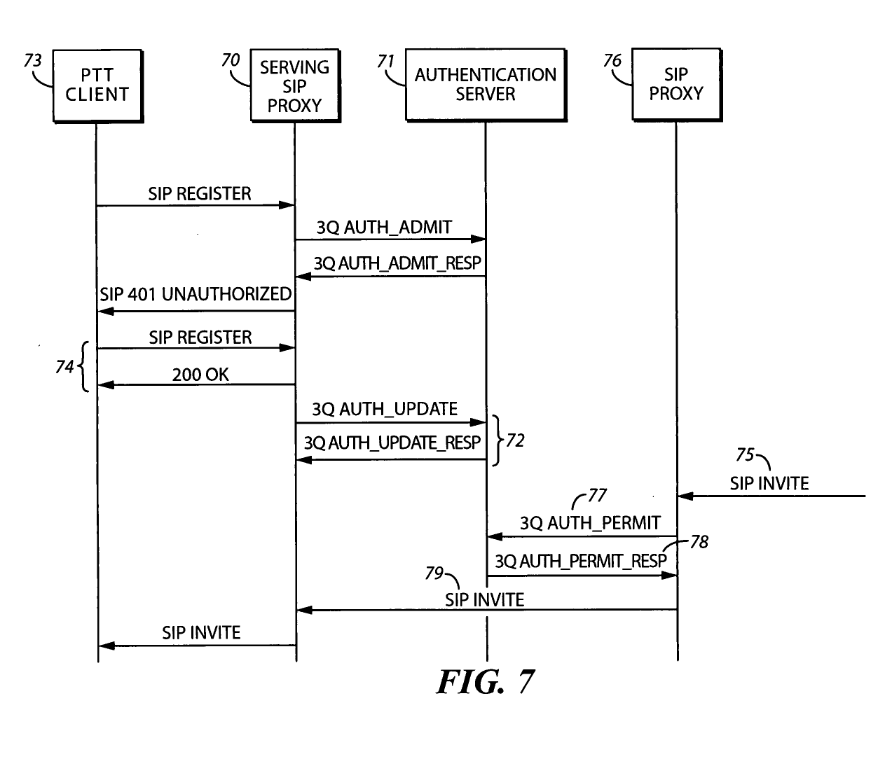

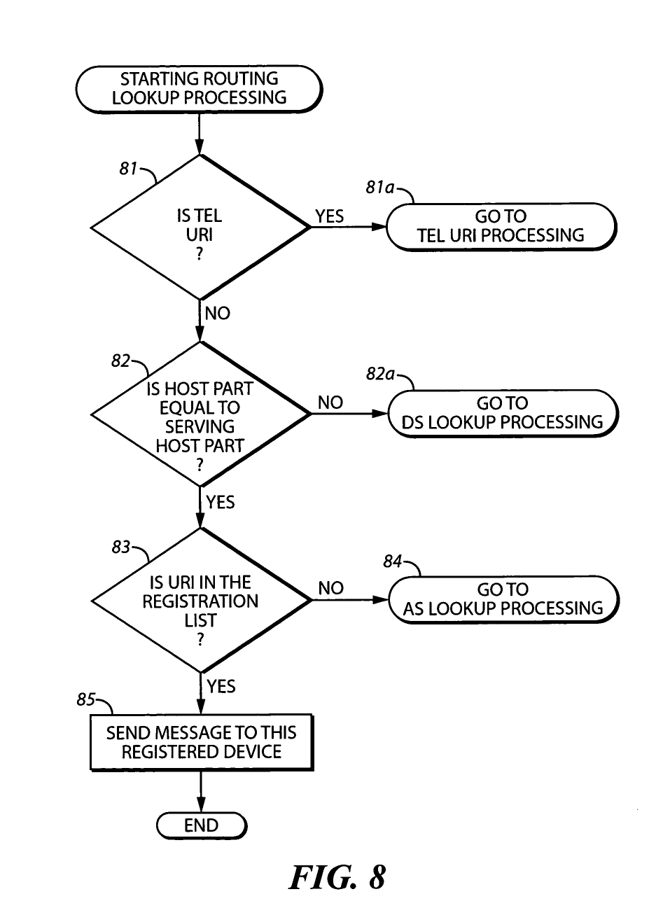

Referring now to FIG. 7, one approach to effecting this support requires a serving SIP proxy 70 to inform 72 the authentication server 71 that it (the serving SIP proxy 70) is now serving the push-to-talk client 73 following successful registration 74 of that client. When a message 75 arrives at a different local SIP proxy 76 for that push-to-talk client's uniform resource identifier, this different SIP proxy 76 can query 77 the authentication server 71 for the serving SIP proxy's address. Upon receiving this address 78 from the authentication server 71, this SIP proxy 76 can forward 79 the message to the serving SIP proxy 70. In a preferred approach the process will now proceed without a need for the different SIP proxy 76 to any longer be a part of the communication process.

In a preferred push-to-talk deployment, an SIP proxy will be located between the push-to-talk clients and the push-to-talk server(s). SIP traffic to this SIP proxy will typically flow from the mobile clients to the push-to-talk server(s) and from the push-to-talk server(s) to the mobile clients. It is also possible, however, that traffic can come from another SIP proxy in the system when multiple proxies are deployed in the same domain or in multiple domains. Additionally, there may be SIP traffic between two or more push-to-talk servers.

In a preferred approach, the following traffic patterns are valid for SIP requests:
Case 1: Mobile client=>SIP proxy=>push-to-talk server(s) (INVITE, SUBSCRIBE, PUBLISH, and so forth)
Case 2: Push-to-talk server=>SIP proxy=>mobile client (INVITE, NOTIFY, and so forth)
Case 3: Push-to-talk server=>SIP proxy=>SIP proxy=>mobile client (INVITE, and so forth)
Case 4: Push-to-talk server=>presence server=>presence server=>push-to-talk server (SUBSCRIBE, NOTIFY, and so forth)

Preferably, all SIP responses follow the via path and there is no need for special routing considerations. NOTIFY, BYE, CANCEL, and ACK messages preferably follow the prior created route and no special routing is required. REGISTER messages are terminated on the SIP proxy and thus require no subsequent routing (though it may be desirable in some cases to forward an SIP REGISTER message in some cases to facilitate certain roaming cases). The three typical requests (INVITE, SUBSCRIBE, and PUBLISH) typically require the SIP proxy to determine a particular route to ensure correct placement of the message.

All three messages (INVITE, SUBSCRIBE, and PUBLISH) can be routed to the push-to-talk server(s). In general, it is likely preferable to always route the message initiated by a mobile client to the push-to-talk server(s).

The request-uniform resource identifier in both INVITE and SUBSCRIBE requests typically explicitly indicates the targeting network element. The SIP proxy will preferably take this uniform resource identifier value from these two messages as given for the following described routing lookup procedure.

For PUBLISH, the request uniform resource identifier is not pointing to the network element but to the push-to-talk client. The SIP proxy will typically require more information beyond what is contained in the PUBLISH message. To meet this need the SIP proxy can provide a configurable called (for example) “PUBLISH server destination” in combination with a corresponding string value. Illustrative values include “publish@a.operator.com” and “presence@a.operator.com.” The SIP proxy can use this value as the destination when processing the routing for the PUBLISH message.

To summarize, the SIP proxy can take the following as the destination uniform resource identifier for each of these three messages:
INVITE
   Destination is extracted from the request uniform resource identifier
SUBSCRIBE
   Destination is extracted from the request uniform resource identifier (absent the tag)
PUBLISH
   Destination is obtained from the configurable

Each of these destinations will typically have routes provisioned in the directory server. The SIP proxy can query the directory server for route resolution. For example, there may be multiple routes provisioned in the directory server mapping to the publish server destination to provide redundancy and/or multiple publish server cases.

In general, only INVITE SIP request messages intended for a push-to-talk client will require routing. In such a case the SIP proxy may need to determine whether to send the request directly to the push-to-talk client or via another SIP proxy. This decision can preferably be based upon whether the push-to-talk client is registered to this particular SIP proxy.

When the push-to-talk client domain is not the local domain or otherwise local to the SIP proxy (for example, the local serving domain of the SIP proxy is “users.a.operator.com” but the SIP uniform resource identifier for the push-to-talk client is “user3@users.b.operator.com”), the SIP proxy can route the INVITE to an appropriate SIP proxy in the target domain. The directory server can be queried to facilitate identification of this SIP proxy. The SIP proxy can provide a configurable to define the local serving domain, whose value shall match the host part of the client's uniform resource identifier that is to be served by this SIP proxy (for example, for a client with host part value “users.a.operator.com,” this configurable can be defined as “users.a.operator.com”). The SIP proxy can use this value to quickly identify whether a given client is within the serving domain.

When the target domain is local, the SIP proxy can search its local registration table. This search will typically not be a linear search (that is, a binary search or a search of a well-designed hash table will frequently be required). When the local registration table contains the push-to-talk client, the INVITE message can be sent directly to that client. When the target domain is local but the local registration label does not include the push-to-talk client, then either the client is registered with another SIP proxy in the local domain or the client is not registered at all. The SIP proxy can query the authentication server to determine if the authentication server knows the serving SIP proxy. When the authentication server returns another SIP proxy's Internet Protocol address, the local SIP proxy can forward the message to the serving SIP proxy. Otherwise, the push-to-talk client has not previously registered with this network and an appropriate error message can be returned to the client.

Route caching can be used to improve system performance by reducing internal traffic between the SIP proxy(ies) and the directory server. Proper provisioning of the cache policy on the directory server can lead to improved performance while not sacrificing routing accuracy. A given SIP proxy can cache at least some routes as returned by the directory server based on a system level configurable. This configurable can support defining whether the route cache shall be used (or not) with a default value of “disabled.” With the configurable disabled, the SIP proxy will not cache any route information. When enabled, however, the SIP proxy can cache the route as returned by the directory server with a non-zero lifetime for at least the number of seconds specified by the non-zero lifetime. Upon expiration of the non-zero lifetime the SIP proxy can then delete the route from its cache.

When caching route information as described above, in a preferred approach the SIP proxy will only use the cached results for a subsequent route query when the new destination exactly matches the cached destination. For example, if in a query to the directory server the SIP proxy obtains the route “149.112.150.100” for the destination “server-x@op.com,” then this route will preferably only be used for subsequent queries that have the exact destination “server-x@op.com.”

When caching route information, it is possible to cache more than one route for a same destination. When this occurs, the SIP proxy can randomly select a first route to apply in a given situation. In a preferred embodiment, when the cache lifetime for any route of a plurality of routes for a common destination expires, the SIP proxy will expire the entire plurality of routes. This approach will tend to avoid a skewed routing pattern that can occur when some routes expire while others do not.

In a preferred approach, the SIP proxy will cache up to a configurable maximum number of directory route results. As an example, the configurable can have a default value of 20 and a permitted range of from 10 to 100. When the resultant list is about to exceed the limit, the SIP proxy can automatically remove the least frequently used item from the list. As another approach, a first-in, first-out approach can be employed.

As noted above, the SIP proxy will accept both SIP uniform resource identifiers and telecommunications uniform resource identifiers as a method of identifying a given push-to-talk client. In a preferred approach this includes telecommunications uniform resource identifiers that lack a domain name. Pursuant to a preferred approach, whenever a client presents a telecommunications uniform resource identifier without a domain name, the SIP proxy will first assume that the client is in the local domain and perform the local domain route resolution procedure. The SIP proxy proceeds with the inter-domain case only after the intra-domain procedure returns no route. Other presumptions could of course be selected, but in the usual application an intra-domain call will typically be more likely than an inter-domain call. In addition, intra-domain routing will usually consumer fewer system resources than the inter-domain case.

Additional description regarding SIP proxy routing logic in an illustrative embodiment will now be provided.

Referring to FIG. 8, and in response to receiving an SIP request from a wireless push-to-talk client, the SIP proxy determines 81 whether the request presents a telecommunications uniform resource identifier. When true, the SIP proxy proceeds with telecommunications uniform resource identifier-based processing 81a (described below in more detail). When false, the SIP proxy next determines 82 whether a host part of the identifier is equal to the serving host part. When false, the SIP proxy proceeds with a directory server lookup 82a as described below. When true, however, the SIP proxy then determines 83 whether the present registration list has a match for the presented uniform resource identifier. When false, the SIP proxy proceeds with an authentication server lookup 84 as described below. When true, the SIP proxy sends 85 the message to the corresponding registered device.

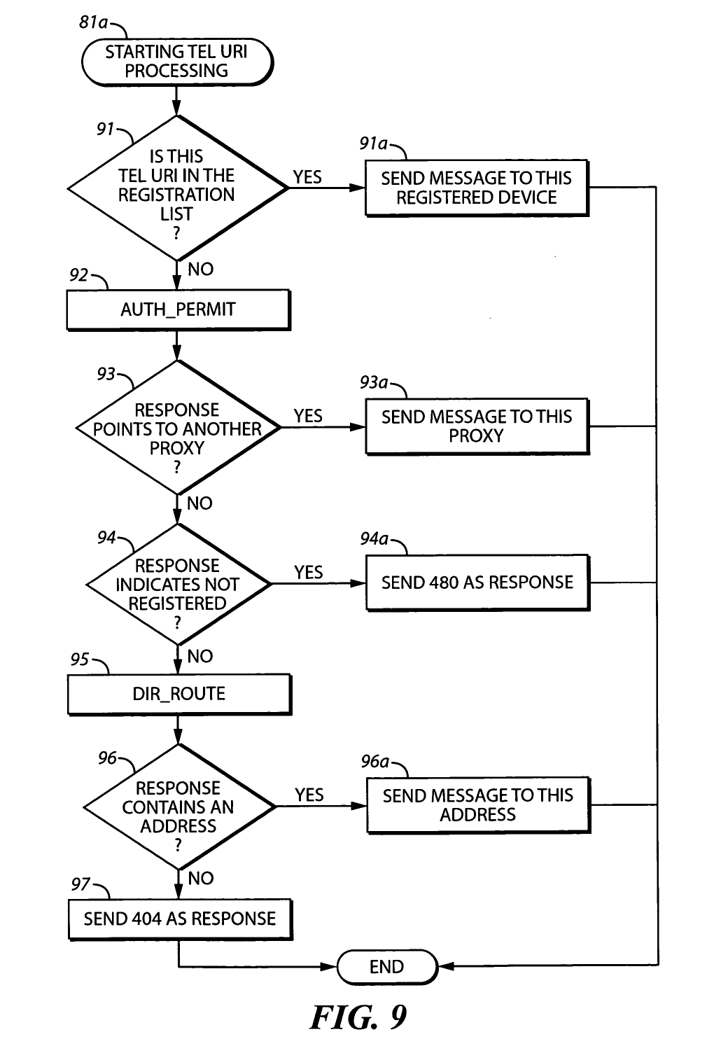

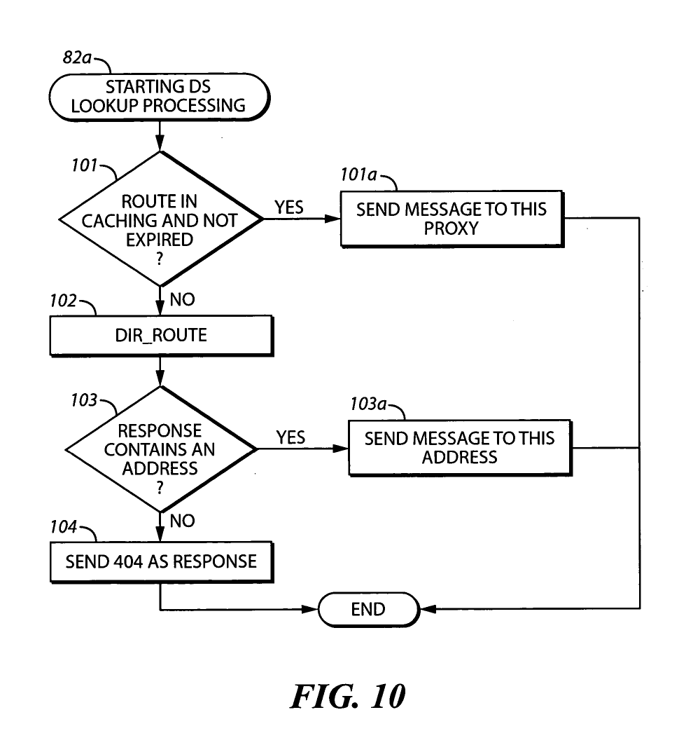

Referring now to FIG. 9, the telecommunications uniform resource identifier-based processing 81 a noted above will be described in more detail. The SIP proxy first determines 91 whether this telecommunications uniform resource identifier matches a corresponding entry in the registration list. When true, the SIP proxy proceeds to send 91a the corresponding message to the registered device. When false, the SIP proxy sources 92 an AUTH_PERMIT SIP message to the authentication server.

The SIP proxy then determines 93 whether the authentication server response points to another SIP proxy. When true, the SIP proxy forwards 93a the message to that other SIP proxy. When false, the SIP proxy then determines 94 whether the authentication server response indicates that the push-to-talk client is presently unregistered. When true, the SIP proxy sources 94a a “480” message. When false, however, the SIP proxy effects a DIR_ROUTE message 95 and then determines 96 whether a corresponding response contains an address. When true, the SIP proxy sends 96a the message using this. When false, the SIP proxy then concludes this process by sourcing 97 a “404” error case message as a response.

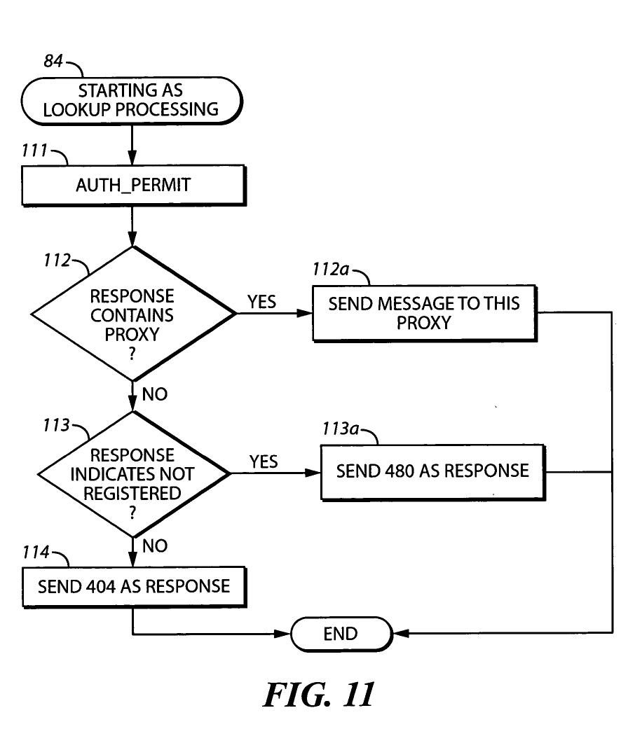

Referring now to FIG. 10, the directory server lookup process 82a will be described. As noted above, the SIP proxy proceeds with this process upon determining that the host part of the proffered non-telecommunications uniform resource identifier is not equal to a serving host part. The SIP proxy now determines 101 whether the available cache has a corresponding non-expired route. When true, the SIP proxy uses this route to send 101a the message to the corresponding SIP proxy. When false, the SIP proxy sources 102 a DIR_ROUTE message to the directory server. The SIP proxy then determines 103 whether a directory server response contains an address. When true, the SIP proxy uses that address to send 103a the message. When false, however, the SIP proxy concludes by sourcing 104 a “404” error case message as a response.

Referring now to FIG. 11, the authentication server lookup process 84 will be described. As set forth above, the SIP proxy proceeds with this process upon determining that the proffered non-telecommunications uniform resource identifier has no counterpart in the registration list. The SIP proxy begins by sourcing 111 an AUTH_PERMIT message to the authentication server. The SIP proxy then determines 112 whether the authentication server contains proxy information. When true, the SIP proxy sends 112a the message to the indicated SIP proxy. When false, the SIP proxy next determines 113 whether the authentication server response indicates that the indicated push-to-talk client is not registered. When true, the SIP proxy sources 113a a “480” message as a response. When false, the SIP proxy instead sends 114 a “404” error case message as a response.

As noted earlier, in a preferred embodiment the SIP proxy will support compression and decompression of SIP messages as exchanged with the push-to-talk wireless client. In general, it is preferred that SIP compression only be supported as between the mobile client and the first-hop SIP proxy. In particular, the SIP proxy will not, in a preferred approach, advertise SIP compression support to any other elements or devices.

To provide such support, the SIP proxy message decoding and parsing engine will preferably be arranged and configured to recognize compressed SIP messages and to call the appropriate routines to decode these messages. Similarly, the encoding engine will preferably be arranged and configured to determine, based on state and policy, when the SIP messages directed at a mobile client need to be compressed. When using compression, the messages will preferably be compressed after they are appropriately otherwise constructed.

In a preferred approach the push-to-talk client will signal support of SIP compression in both forward and reverse directions in SIP requests that are sent to the SIP proxy. The SIP proxy can signal support of SIP compression in both the forward and reverse directions in SIP requests that it transmits to the push-to-talk client.

Preferably such compression support will be transparent to the rest of the SIP proxy's logic. That is, the SIP proxy's higher level functionality (such as but not limited to endpoint registration, SIP authentication, call setup, call modification, call release, and message routing) shall be essentially (or exactly) the same regardless of whether these elements employ SIP compression. The particular compression supported will preferably be at least based upon SIGCOMP (see Request For Comments 3320 as published by The Internet Society, incorporated herein by this reference) and DEFLATE (see Request for Comments 1951 as published by The Internet Society, incorporated herein by this reference).

The above detailed description of a number of specific embodiments are again to be taken as merely illustrative of the breadth and scope of the teachings set forth here in. Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

For example, these teachings can be readily employed in a system that typically only supports clients that each have only a single common form of uniform resource identifier. Configuring, for example, an SIP proxy in accord with these teachings will permit that SIP proxy to operate in a variety of systems and to operate compatibly with a variety of differing client uniform resource identifiers. Such commonality, in turn, often leads to economies of scale and other competitive advantages for the manufacturer and system designer.

As another example, teach teachings can also be readily employed in a system that supports clients that each have only a single uniform resource identifier, but where different clients may use different forms of uniform resource identifier.

We claim:

1. A system to facilitate session initiation protocol (SIP) proxy-based support of routing as regards communications for at least a given region, comprising:
at least one SIP proxy dedicated, at least in part, to supporting routing of communications for a plurality of clients in the given region, wherein at least some of the plurality of clients each have a plurality of differing user identifiers and wherein, for at least one of the plurality of clients, at least two of the plurality of differing user identifiers each corresponds to a same first communication service;
at least one memory operably coupled to the at least one SIP proxy.

2. The system of claim 1 wherein the at least one SIP proxy comprises at least two SIP proxies.

3. The system of claim 1 wherein the at least two of the plurality of differing user identifiers that each corresponds to a same communication service further comprises at least two of the plurality of differing user identifiers that each corresponds to a push-to-talk communication service.

4. The system of claim 1 wherein one of the plurality of differing user identifiers comprises an identifier having a standard SIP uniform resource identifier format and wherein another of the plurality of differing user identifier comprises an identifier having a standard telecommunications uniform resource identifier format.

5. The system of claim 1 wherein the at least one SIP proxy operably couples to a push-to-talk server.

6. The system of claim 1 and further comprising at least one additional SIP proxy dedicated, at least in part, to supporting routing of communications for a second plurality of clients in a second region, wherein at least some of the second plurality of clients each have a plurality of differing user identifiers and wherein, for at least one of the second plurality of clients, at least two of the plurality of differing user identifiers each corresponds to the first communication service.

7. The system of claim 6 wherein the at least one SIP proxy as is dedicated to the region is operably coupled to the at least one additional SIP proxy as is dedicated to the second region.

8. The system of claim 6 wherein a wireless coverage area as corresponds to the region at least partially overlaps with a wireless coverage area as corresponds to the second region.

9. The system of claim 6 wherein a wireless coverage area as corresponds to the region does not overlap with any part of a wireless coverage area as corresponds to the second region.

10. The system of claim 6 and further comprising at least one further additional SIP proxy dedicated, at least in part, to supporting to supporting routing of communications for a third plurality of clients in a third region, wherein at least some of the third plurality of clients each have a plurality of differing user identifiers and wherein, for at least one of the third plurality of clients, at least two of the plurality of differing user identifiers each corresponds to a same communication service.

11. The system of claim 1 wherein the at least one SIP proxy supports SIP compression.

12. The system of claim 11 wherein the at least one SIP proxy supports SIP compression to thereby improve airlink utilization as between a given one of the push-to-talk clients and the at least one SIP proxy.

13. The system of claim 12 wherein the at least one SIP proxy comprises a first hop SIP proxy with respect to the given one of the push-to-talk clients.

14. The system of claim 1 wherein the at least one SIP proxy supports push-to-talk styled communications for roaming push-to-talk clients in the given region.

15. The system of claim 1 wherein the at least one SIP proxy supports inter-region push-to-talk styled communications as between push-to-talk clients that are located in different regions.

16. The system of claim 1 wherein the at least one SIP proxy further supports presence service.

17. The system of claim 16 wherein the at least one SIP proxy further supports presence service for at least some of the plurality of push-to-talk clients within the given region.

18. The system of claim 1 wherein the given region comprises a plurality of push-to-talk service domains each having a corresponding uniform resource identifier domain name.

19. The system of claim 1 wherein the given region comprises a push-to-talk service domain of a push-to-talk service having a plurality of push-to-talk service domains each having a corresponding uniform resource identifier domain name.

20. The system of claim 1 wherein the user identifiers for the plurality of clients have at least one of a domain name and a sub-domain name that is distinct from any domain name and sub-domain name, respectively, as is assigned to any network component in the system.

21. The system of claim 1 wherein the at least one SIP proxy further comprises authentication and registration means for facilitating authentication of push-to-talk clients.

22. The system of claim 21 wherein the authentication and registration means are further for serving as a registrar for mobile clients.

23. The system of claim 21 wherein the authentication and registration means are further for accommodating a push-to-talk client that presents either of at least two different available-to-the-client client uniform resource identifiers.

24. The system of claim 1 wherein the at least one SIP proxy further comprises routing means for making routing decisions for SIP messages as are provided thereto.

25. The system of claim 24 wherein the routing means are further for facilitating routing decisions in conjunction with a directory server.

26. The system of claim 24 wherein the routing means are further for making the routing decisions for all SIP messages as are provided thereto.

27. The system of claim 1 wherein the at least one SIP proxy further comprises compression means for compressing and decompressing SIP traffic to and from a corresponding one of the push-to-talk clients.

28. The system of claim 1 wherein the at least one SIP proxy further comprises presence means for supporting presence within the system, at least in part, by supporting SIP/SIMPLE messages.

29. A method to facilitate session initiation protocol (SIP) proxy-based support of routing as regards communications for at least a given region, comprising:
providing at least one SIP proxy dedicated, at least in part, to supporting routing of communications for a plurality of clients in the given region, wherein at least one of the plurality of clients has at least two differing uniform resource identifiers by which to identify itself;
when receiving a communication from the at least one of the plurality of clients that uses a first one of the at least two differing uniform resource identifiers, automatically facilitating a first kind of communication for that client;
when receiving a communication from the at least one of the plurality of clients that uses a second one of the at least two differing uniform resource identifiers, which second one of the at least two differing uniform resource identifiers is different from the first one of the at least two differing uniform resource identifiers, automatically facilitating the first kind of communication for that client.

30. The method of claim 29 wherein the first one of the at least two differing uniform resource identifiers comprises an SIP uniform resource identifier.

31. The method of claim 29 wherein the second one of the at least two differing uniform resource identifiers comprises a telecommunications uniform resource identifier.

32. The method of claim 29 and further comprising:
providing the at least one SIP proxy with a system name having a domain name portion that is different than any domain name as is assigned to any of the plurality of clients.

33. The method of claim 29 wherein the at least one SIP proxy comprises a plurality of SIP proxies and wherein the given region comprises a plurality of push-to-talk domains and further comprising:
assigning at least some of the plurality of SIP proxies to different ones of the push-to-talk domains.

34. The method of claim 29 wherein automatically facilitating a first kind of communication for that client further comprises automatically facilitating a push-to-talk communication for that client.

35. The method of claim 34 wherein automatically facilitating a push-to-talk communication for that client further comprises automatically facilitating a wireless push-to-talk communication for that client.

36. The method of claim 34 wherein automatically facilitating a push-to-talk communication for that client further comprises automatically facilitating a wireline push-to-talk communication for that client.

37. The method of claim 29 and further comprising:
upon receiving a communication from a first one of the plurality of clients, automatically authenticating the first one of the plurality of clients via the at least one SIP proxy.

38. The method of claim 37 and further comprising:
automatically authenticating the first one of the plurality of clients via the at least one SIP proxy using an authentication server.

39. The method of claim 29 and further comprising:
upon receiving an SIP communication from a first one of the plurality of clients, automatically decompressing the SIP communication.

40. The method of claim 29 and further comprising:
automatically compressing an SIP communication to provide a compressed SIP communication intended for receipt by at least one of the plurality of clients.

41. The method of claim 40 wherein automatically compressing an SIP communication to provide a compressed SIP communication intended for receipt by at least one of the plurality of clients further comprises automatically compressing an SIP communication to provide a compressed SIP communication intended for wireless receipt by at least one of the plurality of clients.

42. The method of claim 29 and further comprising:
upon receiving an SIP communication from a first one of the plurality of clients, automatically publishing presence information regarding the first one of the plurality of clients.

43. A session initiation protocol (SIP) proxy comprising:
an SIP proxy engine;
a memory operably coupled to the proxy engine;
a push-to-talk server interface to facilitate operably coupling the SIP proxy engine to a push-to-talk server;
wherein the SIP proxy engine has at least a first mode of operation wherein the SIP proxy engine will facilitate a push-to-talk communication for a push-to-talk client that communicates an SIP message to the SIP proxy containing either of two different client identifiers as are available to that push-to-talk client.

44. The SIP proxy of claim 43 wherein the first mode of operation further facilitates decompression of compressed SIP messages as are received from the push-to-talk client.

45. The SIP proxy of claim 43 wherein the first mode of operation further facilitates compression of SIP messages as are transmitted to the push-to-talk client.

46. The SIP proxy of claim 43 wherein the first mode of operation further facilitates authentication and registration of the push-to-talk client.

47. The SIP proxy of claim 43 wherein the first mode of operation further facilitates making routing decisions for SIP messages as are sourced by the push-to-talk client.

48. The SIP proxy of claim 43 wherein the first mode of operation further facilitates supporting distribution of presence information regarding the push-to-talk client.

49. The SIP proxy of claim 43 wherein the first mode of operation further facilitates a roaming communication for the push-to-talk client.

50. A method comprising:
receiving a message comprising a uniform resource identifier;
when the uniform resource identifier comprises a telecommunications uniform resource identifier, recognizing the uniform resource identifier as being a telecommunications uniform resource identifier and processing the message accordingly;
when the uniform resource identifier has a host portion that is the same as a serving host portion, recognizing that the host portion is the same as a serving host portion and processing the message accordingly;
when the uniform resource identifier matches an entry in a registration list, recognizing that the uniform resource identifier matches the entry in the registration list and processing the message accordingly.

51. The method of claim 50 wherein receiving a message comprising a uniform resource identifier comprises receiving a message as part of a communications exchange to facilitate provision of push-to-talk communication services.

52. The method of claim 50 wherein recognizing the uniform resource identifier as being a telecommunications uniform resource identifier and processing the message accordingly further comprises processing the message by:
when the telecommunications uniform resource identifier matches an entry for a registered device in a registration list, facilitating transmission of a message the registered device.

53. The method of claim 50 wherein recognizing the uniform resource identifier as being a telecommunications uniform resource identifier and processing the message accordingly further comprises processing the message by:
sourcing a transmission to determine whether a proxy exists having a pre-established relationship with respect to the telecommunications uniform resource identifier;
when a response to the transmission identifies such a proxy, facilitating transmission of at least a portion of the message to the proxy.

54. The method of claim 53 wherein recognizing the uniform resource identifier as being a telecommunications uniform resource identifier and processing the message accordingly further comprises processing the message by:
when the response to the transmission indicates that the telecommunications uniform resource identifier does not correspond to a registered device, facilitating transmission of a predetermined response.

55. The method of claim 54 wherein the predetermined response comprises a Session Initiation Protocol 480 response.

56. The method of claim 50 wherein recognizing the uniform resource identifier as being a telecommunications uniform resource identifier and processing the message accordingly further comprises processing the message by:
when the response to the transmission indicates that the telecommunications uniform resource identifier does not correspond to a known uniform resource identifier, facilitating transmission of a predetermined communication.

57. The method of claim 56 wherein the predetermined communication comprises a request for directory routing information.

58. The method of claim 57 wherein recognizing the uniform resource identifier as being a telecommunications uniform resource identifier and processing the message accordingly further comprises processing the message by:
receiving a response to the request for directory routing information;
when the response to the request for directory routing information comprises an address, using the address to facilitate transmission of at least a portion of the message.

59. The method of claim 50 wherein recognizing that the host portion is the same as a serving host portion and processing the message accordingly further comprises processing the message by:
determining whether the uniform resource identifier has a corresponding unexpired cached route.

60. The method of claim 59 wherein recognizing that the host portion is the same as a serving host portion and processing the message accordingly further comprises processing the message by:
the uniform resource identifier has a corresponding unexpired cached route, facilitating transmission of a least a portion of the message to a proxy associated with the unexpired cached route.

61. The method of claim 59 wherein recognizing that the host portion is the same as a serving host portion and processing the message accordingly further comprises processing the message by:
facilitating transmission of a predetermined communication comprising a request for directory routing information.

62. The method of claim 61 wherein recognizing that the host portion is the same as a serving host portion and processing the message accordingly further comprises processing the message by:
receiving a response to the request for directory routing information;
when the response to the request for directory routing information comprises an address, using the address to facilitate transmission of at least a portion of the message.

63. The method of claim 50 wherein recognizing that the uniform resource identifier matches the entry in the registration list and processing the message accordingly further comprises processing the message by:
sourcing a transmission to determine whether a proxy exists having a pre-established relationship with respect to the uniform resource identifier;
when a response to the transmission identifies such a proxy, facilitating transmission of at least a portion of the message to the proxy.

64. The method of claim 63 wherein recognizing that the uniform resource identifier matches the entry in the registration list and processing the message accordingly further comprises processing the message by:
when the response to the transmission indicates that the uniform resource identifier does not correspond to a registered device, facilitating transmission of a predetermined response.

65. The method of claim 64 wherein the predetermined response comprises a Session Initiation Protocol 480 response.
